(19) United States
(12) Patent Application Publication
(10) Pub. No.: US 2022/0092283 A1
(43) Pub. Date: Mar. 24, 2022

(54) Integrating Machine- and Human-Interpretable Symbols

(71) Applicant: Christopher Adam McLeod, Toronto (CA)

(72) Inventor: Christopher Adam McLeod, Toronto (CA)

(21) Appl. No.: 17/378,737

(22) Filed: Jul. 18, 2021

Related U.S. Application Data
(60) Provisional application No. 63/082,732, filed on Sep. 24, 2020.

(51) Int. Cl. G06K 7/10; G06K 7/14; G06K 19/06

(52) U.S. Cl. CPC G06K 7/10722; G06K 19/06103; G06K 7/1417

(57) ABSTRACT

Toward the memorization of diverse metadata associated with a given kanji ideogram, a package is conceived wherein printed cards branded with QR codes on the card or directly on the kanji ideogram are read with the camera of a mobile device and the user is then furnished with metadata about the kanji ideogram germane to learning about the ideogram, as enabled by a software tool installed or available to the mobile device user, this software processing the QR code to reproduce the reading and other metadata. In place of a printed card, an electronic facsimile on the mobile device could also be used, wherein the QR code is sensed by the software tool.

### FIELD OF THE INVENTION

This Invention relates generally to integration of machine- and human-interpretable symbols, such as kanji ideograms and QR codes, bar codes, and other machine-readable symbols, in order to link the human-interpretable symbols with data representing instructive information useful in creating learning opportunities through execution of computer applications.

### BACKGROUND OF THE INVENTION

Logograms and ideograms are human-interpretable symbols used for a variety of purposes, including for example rendering of some written languages, such as Chinese, Japanese, and Korean. Logograms are non-phonetic written symbols that represent words or morphemes, while ideograms represent ideas in the broadest sense. Kanji, for example, are ideograms sometimes used in the rendering of the Japanese language.

The learning of Japanese and other languages can be greatly complicated by the need for students to memorize a very large number of symbols and their associated meanings, often within multiple specific contexts, in order to correctly render an interpretation. Once the confine of academia and business, the learning of such languages is now supported by a larger population of people, including for example those wishing to explore the realms of manga comics, anime animations, and, various gaming experiences. Despite the evolution of computer-mediated translation, the effort to learn how to read these languages to follow these interests is still deemed a worthy pursuit by students worldwide. In various aspects and embodiments, the invention described in this Application provides instructional and memorization aids useful in learning metadata associated with Japanese kanji and other ideograms imbued with multiple information characteristics known only to those who have memorized those characteristics to be associated with a given ideogram. This plurality of information characteristics includes but is not limited to reading pronunciations associated with various contextual or other meanings in audio format; reading pronunciations in text form; meaning in a plurality of languages; including languages other than those primarily associated with the ideograms; writing stroke order, stroke count, lead component; memorization aid mnemonic(s); historical, obsolete, or older versions of the ideogram(s); origins in nature; standardized ordinals for education; standardized ordinals for computer standards; sample kanjukugo or other noun kanji pairs or combinations or grammatical or other usage sentences, and equivalent ideograms in other languages that also use ideograms.

In this Invention tools to learn the branding (i.e., contextual meaning(s)) of kanji and other ideograms are provided, by for example making new uses of known communication tools such as the worldwide Internet of linked servers and client computers, mobile phone programs called apps if local, web-apps if accessed via a browser Internet search program, branding information codes such as QR square bar code technology representing at least link(s) to dedicated information sets such as web pages at given URLs (uniform resource locaters) in app(s) or web-app(s) controlling access to information on said information page, data representing visual, audio and other formats of information, and the use of a mobile screen device(s) such as a cellular telephone(s) configured to capture and optionally interpret QR and other information codes. Metadata refers to any linguistic information associated with kanji or other ideogram(s).

Fluency in reading of Japanese and other languages rendered using ideograms is enabled by the memorization of kanji or other ideograms and their information characteristics. While the traditional flip card method is still a critical tool to writing the characters to human memory, this memorization method has always been hindered by the necessity of reference to a plurality of dictionaries, paper or electronic, for that metadata which has not yet been memorized, most notably reading but also stroke order and other necessary information characteristics, distracting focus on memorization.

### SUMMARY OF THE INVENTION

Accordingly, it is an object of this invention to at least partially overcome some of the disadvantages of the prior art.

Preparation of cards preprinted with kanji ideograms with QR codes also imprinted on the card face can enable the user to scan the code. Using a mobile device that can read the QR code and appropriately transmit that information to an app or web app on that device and configured to provide the reading of the ideogram and other metadata improves the memorization experience. The card may also be virtual; that is, within the app.

### BRIEF DESCRIPTION OF THE DRAWINGS

In the drawings, which illustrate embodiments of the invention:

FIG. 1 shows branding of a card printed of a kanji ideogram with a QR code;

FIG. 2 shows direct branding of a kanji ideogram on a printed card with QR code;

FIG. 3 shows branding of a kanji ideogram on a printed card with QR code printed on the reverse side of the card;

### DETAILED DESCRIPTION OF THE INVENTION

In some embodiments, aspects of the invention described in this Application comprise a package with at least two components: kanji or other ideogram cards, and an app or web-app installable on a mobile or other data processing device equipped with a camera that can read QR and or other machine-interpretable codes, eliciting metadata retrieval and display or other reproduction by means of an app or web-app installed on said mobile device to aid user(s) of the device(s) in the memorization of a plurality of metadata associated with the ideograms.

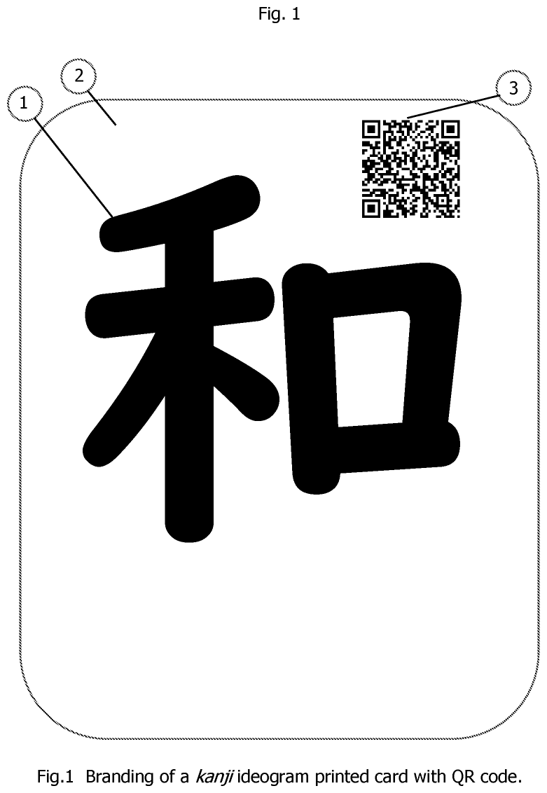

In FIG. 1, a card 2 is imprinted with a kanji ideogram 1 and a QR code 3 is also imprinted on the same side of the card. This enables the user to scan the code with a mobile device equipped with a camera. An app or web app is provided and installed on the mobile device and is configured to access one or more data sets associated with the QR code 3 and display or otherwise provide reading(s) or interpretation(s) associated with the ideogram and/or other metadata in a user-configured order.

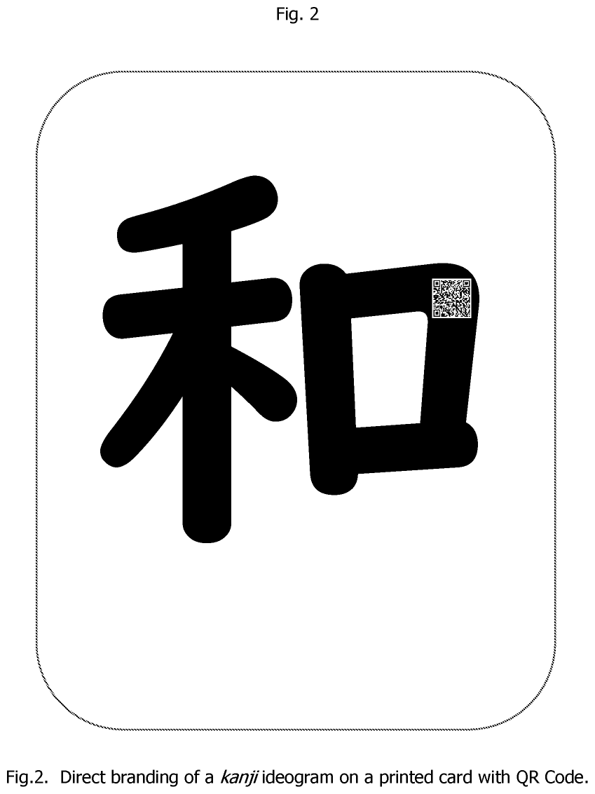

In FIG. 2, a card 2 is imprinted with a kanji ideogram 1 and a smaller QR code 4 is superimposed upon or otherwise also imprinted on the ideogram 1, on the same side of the card. This enables the user to scan the code with a mobile device equipped with a camera. An app or web app is provided and installed on the mobile device and is configured to access one or more data sets associated with the QR code 3 and display or otherwise provide reading(s) or interpretation(s) associated with the ideogram and/or other metadata in a user-configured order.

Preparation of virtual and/or other computer-based kanji ideograms for display or other presentation on a computer with QR codes embedded in the pixels of the characters themselves enables a similar elicitation of metadata reproduction. Instead of the computer program, also known as app or web-app, recognizing the characters themselves, the link between the ideogram and educational information is the QR code rather than recognition of the shape of the character. This allows the kanji ideogram to be read using metadata encoded in the QR code in a manner pre-configured by the user. One example of configuration would be to specify that the Chinese-derived reading or on-yomi is read both in its standard form plus a non-standard but also common reading that occurs in a common jukugo noun pair of kanji ideograms, as in the example for the first kanji ideogram in the common word houken or feudal versus the fuu reading found in fuutou or envelope, when and only when such a choice exists.

Through this use of the QR code branding the kanji ideogram, a range of learning tools from paper cards to facsimiles of cards within an application can be produced, all making use of recognition of the accompanying QR brand toward elicitation of educational metadata concerning that kanji ideogram in the memorization process, in a manner highly configurable depending on the learning style of the user.

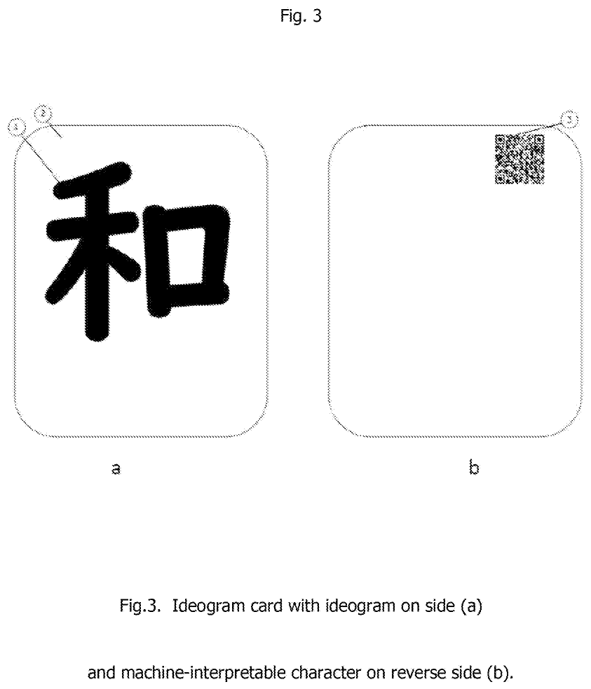

FIG. 3 shows an embodiment of a virtual or physical instructional card 2 comprising a kanji ideogram 1 on a first side (side (a)) of the card 2 and a QR code or other machine-interpretable code 3 imprinted on the reverse side (b) of the card 2. Such embodiments can for example be useful by pairs or other pluralities of users to help each other in interpreting ideograms 1. For example a first user can be presented with the kanji ideogram on side (a), and quizzed by a second or third user as to any one or more of its interpretations. The first user's interpretation(s) can be checked, coached, or otherwise assisted by one or more second or thirds user by, for example, use of a mobile or other device to read a code 3 provided on side (b) and access data representing interpretations and other information associated with the ideogram 1 without the first user being tempted or otherwise enabled to check the card him/herself, so that he/she is required to put a desired amount of effort into interpreting the ideogram before being provided with the answer. Any desired reward(s) can be offered by the second or third users for successful performance by the first user, and/or any desired form of negative reinforcement can be provided in case of failure.

While computerization of kanji ideograms has enabled elaboration of learning strategies, the ability to store values for multiple fields associated with a kanji ideogram on a computer with a screen does not relieve the rote nature of learning encountered in learning software for kanji ideograms. The element of fun and games can enhance learning tools, and the use of a QR code embedded into the front or back of a card printed with a kanji ideogram provides a means by which one of many learning games can be enabled for fun learning. An example presented in this Application is a tile accretion game, where the kanji ideogram card decorated with a QR code acts as a game tile or playable piece. A player holding a kanji card guesses at the agreed kanji ideogram value for the game, for example, Japanese pronunciation. Players of differing Japanese fluency can be programmed to be tested on different kanji ideogram values of differing difficulty, for example, stroke count instead of Japanese pronunciation. Fellow players can check the correctness of the answer offered by the first player with a QR code reading application in a device including but not limited to a smart phone with a camera, or a card QR code checking device supplied as part of a game package. If successful, the holder of the kanji ideogram card just successfully identified can use this card as an accretive tile in a tile-type game played on a surface. A kanji ideogram card correctly identified in this way can be termed to have been empowered, or any descriptor indicating utility for the next phase of the game play.

The game example suggested here is similar to many tile accretion games, but using a principle to link tiles, here, kanji ideogram cards, that is peculiar to kanji ideograms. The reason why tile word games do not exist in Japanese is that the majority of words composed of multiple kanji ideograms are only two characters in length, which would lead to a dull tile accretion game if simple word making were the point of the game. However, every kanji ideogram is built up of recognizable sub-components, for example, sub-components meaning water, or grass, or soil. This sub-component matching principle can be used in a tile accretion game, where the tiles are empowered cards. Empowered cards can be matched, on the appropriate side of a kanji ideogram card already laid down, where a sub-component of a newly empowered kanji ideogram card matches a previously kanji ideogram card laid down, for example water sub-component to water sub-component. In this fashion, lines of tiles can be built up in a manner similar matching dot numbers in dominoes, while retaining educational value similar to spelling games through both the QR reading code component just described, as well as by identification of common sub-components through the tiles. Length of lines of joined tiles would depend on chance in kanji ideogram card selection.

The Invention, including for example a printed or virtual pack of kanji ideogram cards, is unique and novel owing to the branding of the cards, or of the ideograms themselves, printed or virtual, with QR codes that enable recognition of the ideograms and their associated metadata.

What is claimed is:

1. A paper card, adorned with the printed image of an Asian kanji ideogram has a QR or other computer-sensible code on the same face as the ideogram, and,
recognition of that QR code by a device such as a mobile phone connected to an app or web-app informs a user of information on the recognized kanji ideogram, including but not limited to, reading pronunciations in audio format, reading pronunciations in text form, meaning in a plurality of languages, writing stroke order, stroke count, lead component, memorization aid mnemonic, older versions of the kanji ideogram, origin in nature, standardized ordinals for education, standardized ordinals for computer standards, and equivalent ideograms in other languages that also use ideograms.

2. As in claim 1, excepting that the QR code or similar code is imprinted directly onto the body of the kanji ideogram.

3. As in claim 2, excepting that the character appears as a computer-based image on a screen, wherein:
software reads that QR code to redirect upon request to a software containing kanji ideogram metadata as described in claim 1.

4. A paper card, adorned with the printed image of an Asian kanji ideogram on a first side of the card, has a QR or other computer-sensible code on a second or opposite side of the card, and,
recognition of that QR code by a device such as a mobile phone connected to an app or web-app informs a user of information on the recognized kanji ideogram, including but not limited to, reading pronunciations in audio format, reading pronunciations in text form, meaning in a plurality of languages, writing stroke order, stroke count, lead component, memorization aid mnemonic, older versions of the kanji ideogram, origin in nature, standardized ordinals for education, standardized ordinals for computer standards, and equivalent ideograms in other languages that also use ideograms.
